(19) United States
(12) Patent Application Publication
(10) Pub. No.: US 2011/0046814 A1
(43) Pub. Date: Feb. 24, 2011

(54) SYSTEM, METHOD AND DEVICE FOR SEGREGATED AND INDEPENDENT COMMAND AND CONTROL OF WIRELESS SERVICE SELECTION, ROUTING, TRANSPORT AND/OR DELIVERY

(75) Inventors: Andrew W. Buffmire, Salt Lake City, UT (US); Peter van der Gracht, Vancouver (CA); Ruskin Taylor Lhamon, Seattle, WA (US); William Patrick Cortes, Bellevue, WA (US)

Correspondence Address: BLACK LOWE & GRAHAM, PLLC, 701 FIFTH AVENUE, SUITE 4800, SEATTLE, WA, 98104, US

(73) Assignee: SIGNALSET, INC., Salt Lake City, UT (US)

(21) Appl. No.: 12/862,027

(22) Filed: Aug. 24, 2010

Related U.S. Application Data
(63) Continuation-in-part of application No. 12/579,810, filed on Oct. 15, 2009.
(60) Provisional application No. 61/236,481, filed on Aug. 24, 2009.
(60) Provisional application No. 61/236,793, filed on Aug. 25, 2009.
(60) Provisional application No. 61/105,737, filed on Oct. 15, 2008.
(60) Provisional application No. 61/110,900, filed on Nov. 3, 2008.

(51) Int. Cl. G06F 7/00; H04B 7/00

(52) U.S. Cl. 701/2; 455/68

(57) ABSTRACT

Systems, methods, and devices are operable to system for communicate with vehicles. An exemplary embodiment employs a vehicle device and a server. The vehicle device is configured to communicate with a control network and at least one carrier. The server is configured to communicate with the control network and the at least one carrier, is configured to communicate command information with the vehicle device using the control network, and is configured to separately communicate information of interest with the vehicle device using the at least one carrier in accordance with the communicated command information communicated over the control network.

### PRIORITY CLAIM

This application is a Non-Provisional Application of Provisional Application Ser. No. 61/236,481 (filed on Aug. 24, 2009) and of Provisional Application Ser. No. 61/236,793 (filed on Aug. 25, 2009). Accordingly, the present application claims priority to and the benefit of the filing dates of Provisional Application Ser. No. 61/236,793 and Provisional Application Ser. No. 61/236,481, which are both incorporated by reference herein in their entirety. This application is a Continuation in part of Non-Provisional application Ser. No. 12/579,810 (filed on Oct. 15, 2009), which claims priority to and the benefit of the filing dates of Provisional Application Ser. No. 61/105,737 and Provisional Application Ser. No. 61/110,900. Accordingly, the present application claims priority to and the benefit of the filing dates of Non-Provisional Application Serial No. 12/579,810, Provisional Application Ser. No. 61/105,737, and Provisional Application Ser. No. 61/110,900, all of which are incorporated by reference herein in their entirety.

### BACKGROUND OF THE INVENTION

A characteristic of the world-wide wireless industry is the development and deployment of competing wireless data and voice transport protocols. These include, for example, deployments of the following technologies by various service providers in the United States and world-wide: Code Division Multiple Access (CDMA), CDMA Evolution Data Optimized (EVDO), EVDO Rev A, Wideband CDMA (WCDMA), Global System for Mobile Communications (GSM) and High-Speed Downlink Packet Access (HSDPA), WiMax and Long-Term Evolution (LTE). All of these platforms provide for the delivery of Voice and Data, a commodity process, albeit over differing protocols, differing discrete systems and differing end-user equipment. Purchasers of the services delivered over these platforms have historically been required to purchase voice and data equipment and terminals uniquely able to acquire only one of these technologies. In addition, the software on the voice and data equipment and terminals has historically been controlled by the carrier providing the equipment and terminals and this software has limited the ability of the purchasers to change networks without, in most instances, changing equipment and/or engaging in an ad-hoc and cumbersome process to change handsets or user devices or change software on existing equipment. As a result changing carriers for the delivery of wireless data and voice services is complicated and cumbersome and, in most instances, requires the change-out of expensive or subsidized equipment.

With the development of increased demand for wireless services and the deployment of more high-speed and high capacity wireless networks the market demand for more flexible and cost-effective wireless services has increased and is increasing. A number of initiatives have been pursued by various industry players in attempting to address this market need. For example, wireless devices have been deployed that will allow for the acquisition of different wireless networks such as, for example, chips to allow laptop computers and other devices to acquire various wireless data networks including, for example, CDMA and HSDPA networks. In addition, software has been deployed on handsets and other terminal devices that allow for the acquisition of signals and networks according to a pre-defined hierarchy such as, for example, a Preferred Roamer List (PRL).

### BRIEF DESCRIPTION OF THE DRAWINGS

FIG. 1 is an overview of an Integrated Control Device with Segregated Wireless Command Control and Wireless Transport.

FIG. 2 is an overview of an Integrated Control Device with Segregated Wireless Command Control and Wireless Transport integrated with a separate control channel network and with various wireless transport technologies and service providers.

FIG. 3 is a listing of command and control channel system commands, information and services.

FIG. 4 is an overview of a Command and Control Network Device Linked to an End-user Device with a Multi-Network Acquisition Capability (the “Linked Control Device”).

FIG. 5 is an overview of a Linked Control Device integrated with a separate control channel network and with various wireless transport technologies and service providers and wireless networks.

FIG. 6 is a listing of additional command and control channel system commands, information and services that can be addressed or implemented through an Integrated Control Device or a Linked Control Device.

FIG. 7 is a perspective view of a truck comprising the improved systems.

FIGS. 8A and 8B illustrate various environments and architectures used in exemplary embodiments;

FIGS. 9A-9B illustrate example software components located on the exemplary device and/or servers of FIG. 8B; and

FIG. 10 illustrates an exemplary software and hardware architecture used in an exemplary embodiment.

### DETAILED DESCRIPTION OF THE PREFERRED EMBODIMENT

Embodiments provide a terminal device that can acquire multiple broadband carrier telecommunication networks (the “Carrier Network”) and can also acquire a separate command, via a control and instruction channel or link, using a separate chip and wireless service radio, with a separate or common antenna able to acquire and receive communications from a network independent from the networks of existing broadband wireless carriers (the “Control Channel”) and which terminal device also provides for implementation of commands from the Control Channel (the “Integrated Control Device”). An exemplary embodiment Embodiments of the Integrated Control Device allow for commands and instructions to be issued over a Command Channel to a group of devices and/or end-user terminals to determine which technology will be deployed for the transport of voice and/or data and/or short message service (SMS), and which Carrier Network will be acquired by a defined group of end-user terminal devices and in what order. Additional embodiments provide for the timing of receipt and the timing of action upon commands and/or actions initiated and/or delivered over the Control Channel and the priority of the timing and actions taken and/or commanded.

Accordingly, this application relates to an Integrated Control Device for a segregated, and independent, wireless command and control over the Control Channel of wireless service selection, wireless transport and wireless communications routing. Embodiments provide for control of the initiation, monitoring, and control of the routing and/or path for the transmission, transport, and delivery of data and/or voice services and/or SMS over a selected Carrier Network. Embodiments provide for, among other things, Carrier Network independent control and delivery of selected services, wireless voice and/or data and/or SMS service technology and transport selection and/or least cost routing over wireless networks and a selected Carrier Network.

Examples of an Integrated Control Device embodiment would use, for example, but not limited to, a multiple technology service chip-set, or the serial linking of separate network components or chip-sets on a common platform, along with the use of an external network and command receipt antenna and chip-set for the Control Channel, such as, for example, a paging network and paging transceiver to receive the paging or independent Control Channel wireless command, or a satellite link antenna and chip, to receive the independent Control Channel wireless command. Embodiments then direct the multiple network chip or the multiple network configured end-user terminal with the Integrated Control Device embodiment to, in turn, acquire a third party network or wireless platform or Carrier Network in the priority and/or order directed, and with the services and capabilities then directed. This Control Channel can also be used for the independent and direct delivery of services directly to end-user devices separate from a Carrier Network and/or integrated with a Carrier Network as determined by the controlling party or entity of the Control Channel.

An additional highly desirable capability of such an Integrated Control Device embodiment is the receipt of confirmation that the commands, instructions and/or controls delivered over the Control Channel have been received and acted upon.

Simply put, the deployment of the Integrated Control Device embodiment to control choice of wireless networks for groups of users over a separate Control Channel will, among other things, bring to enterprise and group purchasers of wireless services the same benefits and controls that resulted from the development and rapid market acceptance of long-distance network choice and least-cost purchase of services over long-distance networks.

In operation, an enterprise, and/or an intermediary representing one or more enterprises or group of end-users, will acquire for a group of users a wireless communication terminal containing an Integrated Control Device embodiment. Embodiments will provide for the ability to choose for the wireless communication terminal a Carrier Network for the delivery of voice and/or data services. The Integrated Control Device will also have the ability to receive through the Control Channel a command and/or instruction that will then determine for the Integrated Control Device the Carrier Network to be used by the Integrated Control Device and/or the wireless communications terminal. This Integrated Control Device and wireless communications terminal will also have the ability to communicate to the enterprise and/or intermediary that the commands, controls and/or instructions delivered over the Command Channel have been successfully received, acted upon and/or implemented. This may include commands, controls and/or instructions for additional independent services delivered over the Command Channel and/or integrated with the Carrier Network. Upon deployment of the Integrated Control Device incorporated into or integrated with the end-user wireless services terminal or equipment and the system and platform supporting the Control Channel, the enterprise and/or intermediary will choose the technology and/or Carrier Network for users or groups of users based upon service and technology availability, geographic area, capacity, capacity by time of day and/or cost and/or other characteristics or elements of the Carrier Network. The choice is then implemented by command to the Integrated Control Device, over the Control Channel. Embodiments then monitor reports of the receipt, action upon and/or subsequent implementation of the controls, commands and instructions delivered over the Control Channel. In some embodiments, the process will be repeated at periodic intervals to optimize the use of wireless transport and its cost by the enterprise or by the intermediary.

The following describes in further detail various of the elements and capabilities of embodiments for the segregated, and/or the independent command and control of wireless service selection, routing, transport and/or delivery.

As a result of the deployment of an embodiment, an independent telecommunications Control Channel, or link, one or more, or a combination of, all or part of the following is provided:

a. A direct wireless channel, wire line channel, or link to an end-user telecommunications device and/or terminal,

b. A wireless channel, wire line channel, or link to an end-user telecommunications device and/or terminal controlled independent from existing Carrier Network and wide-area network voice and data systems,

c. A wireless channel, wire line channel, Control Channel and/or link able to access an end-user telecommunications device and/or terminal that has the capability of accessing multiple wireless networks,

d. The ability over the wireless channel, wire line channel, Control Channel and/or link to deliver instructions to the end-user telecommunications device or terminal to choose and cause the implementation of the choice of separate wireless networks for the transport of voice and/or data services,

e. The ability to receive confirmation that the instruction to select and deliver voice and/or data services over the selected wireless transport network or Carrier Network has been received and implemented.

Another set of capabilities and characteristics of the Integrated Control Device embodiments is the ability to directly receive and act upon independent commands and telecommunications over wireless channel, wire line channel, link and/or Control Channel. An embodiment may be comprised of one or more, or all of, the following:

a. A receiving antenna and chip set that allows for receipt of independent commands and/or instructions,

b. A microprocessor with the capability of translating received commands and/or instructions including but not limited to commands, controls or instructions delivered over the Control Channel for additional action,

c. Software instructions for receiving and acting upon independent commands and/or instructions received,

d. A send and receive antenna and chip set able to select and communicate with the Control Channel and separately communicate with the Carrier Network, apart from the Control Channel,

e. A microcontroller interface between the Integrated Control Device and the Carrier Network acquisition chip-set in a wireless end-user terminal and/or equipment,

f. The software program between the Integrated Control Device embodiment and the Carrier Network access chip-set and/or antenna in a wireless end-user device,

g. The microcontroller and integrated software program between the Integrated Control Device embodiment and the Carrier Network access chip-set in a wireless end-user terminal and/or equipment,

h. The ability to deliver voice and/or data and/or SMS for transport over the selected Carrier Network.

The Integrated Control Device embodiment for providing independent command, control and instructions over end-user wireless terminals and/or devices including but not limited to command, control and instructions over the Control Channel is comprised of one or more, or all of, the following:

a. The deployment and integrated system implementation of a server separate from the wireless carrier transport networks for command and control of the Integrated Control Device embodiment independent of the Carrier Networks,

b. A data-base customer information, usage and/or data repository independent from the Carrier Networks, yet integrated for wireless transport service provisioning over the Carrier Networks,

c. The method and system for collecting data over or separate from the Control Channel and sending instructions based upon that data in connection with an individual, or groups of individual end-users, over the Control Channel,

d. The method and system for reporting of command and service implementation changes over the Control Channel, or, through the signaling channels across and from the Carrier Network.

The Integrated Control Device embodiment provides for separate delivery of commands to a wireless device through a Control Channel. Embodiments provide for one or more or all of the following capabilities:

a. Choice of wireless voice and/or data transport technologies, network and service provider transport and/or Carrier Network,

b. Choice of least cost routing over wireless transport networks and/or a Carrier Network,

c. Choice of the wireless internet browser to be used as the browser (default or ad-hoc) for third party wireless networks and wireless transport services including but not limited to over a Carrier Network,

d. Commands, controls or instructions over the Control Channel for the delivery of end-user equipment location information directly or over a Carrier Network or otherwise,

e. The confirmation of Carrier Network service implementation and/or completion, and the operational functioning of Carrier Network service delivery,

f. Delivery of advertising directly to end-user devices over the Control Channel,

g. Data download and/or upload commands, controls, or instructions over the Control Channel or otherwise including, but not limited to, choice of Carrier Network and/or time of day for the data downloads and/or uploads,

h. Access by software developers and/or end-user customers through application programming interfaces (APIs) to the server and system integrated with and/or controlling the Control Channel,

i. Signals and/or commands over the Control Channel to wake-up or turn-on the terminal and/or end-user communications device and to then commence a pre-determined action that may include initiating access to a Carrier Network,

j. Such other access and capability as may be determined by the controller of the independent Control Channel and such embodiments as may be technically capable of being provided over that Control Channels and related system, method and device now and in the future.

k. The delivery of alerts over the control channel and/or over the Carrier Network.

In summary, what is disclosed herein is a device and system and/or Control Channel for the independent control and delivery of commands and/or instructions, and/or wireless services determination, to wireless end-user devices, terminals and/or equipment. Embodiments provide for choosing the technology, network and/or service provider and/or Carrier Network for the transport of wireless voice and/or data services. Embodiments utilize an independent link or pathway to control the choice of the technology and/or transport network over the Control Channel or otherwise, and provide for an independent verification and/or confirmation of the completion of the network and/or path chosen.

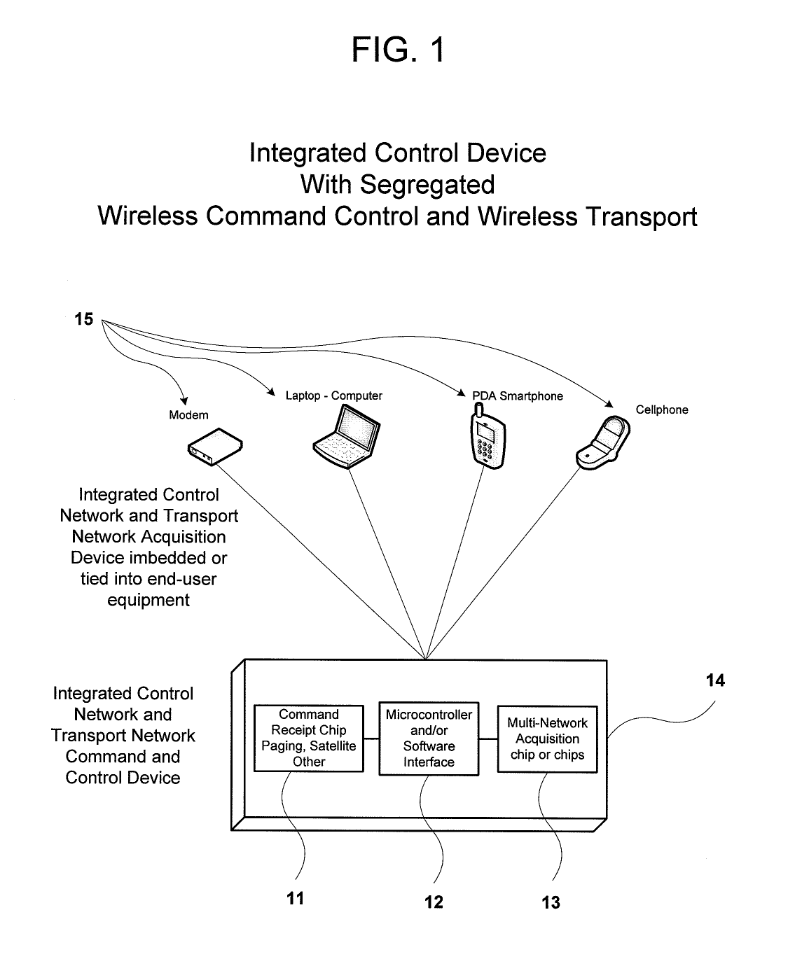

FIG. 1 is an overview of an embodiment of an Integrated Control Device with Segregated Wireless Command Control and Wireless Transport. FIG. 1 provides detail with respect to an integrated control device embodiment that can receive a command on a receiving chip set 11 over a separate Control Channel not controlled by a Carrier Network. Once the command is received, the command is translated through a microcontroller and/or software interface 12 to command the network acquisition chip set 13 to acquire the Carrier Network for wireless voice and data transport. The network acquisition component 13 of the Integrated Control Network and Transport Network Command/Control Device may be comprised of an integrated chip set or it may be comprised of independent chip and transmission components linked to the microcontroller and/or software interface 12. The Integrated Control Network and Transport Network Command/Control Device embodiment is deployed as an integrated unit 14, thus allowing for a uniform, cost-effective and broad deployment of an Integrated Control Device. The Integrated Control Network and Transport Network Command/Control Device is then imbedded or tied into various end-user components and equipment 15 allowing those devices to be re-directed by a command independent of deployed wireless networks or over the Control Channel to provide for voice and data delivery simultaneously over one or more independently selected wireless technology and/or service transport networks and/or Carrier Networks.

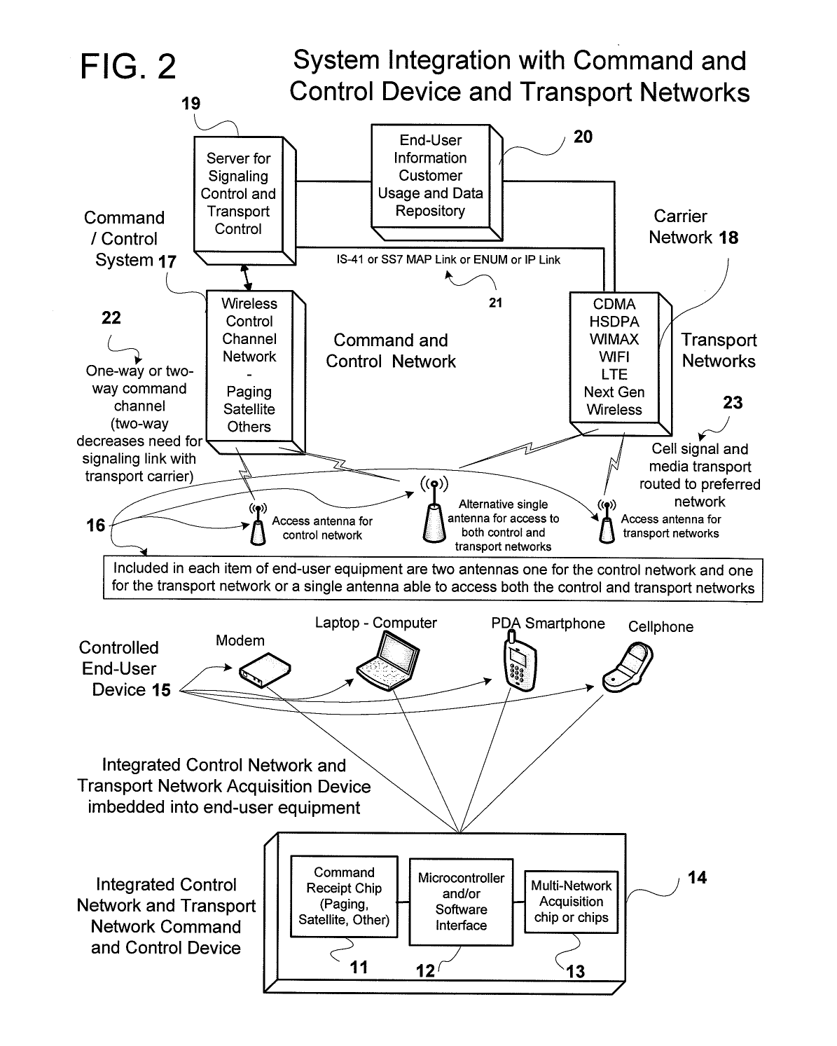

FIG. 2 is an overview of an Integrated Control Device with Segregated Wireless Command Control and Wireless Transport embodiment 14 integrated with a separate control channel network, and integrated with various wireless transport technologies and/or service providers. FIG. 2 shows how the Integrated Control Network and Transport Command/Control Device embodiment 14 is then communicatively integrated into the Carrier Network 18 and a command/control system 17 independent of the Carrier Network 18. It also shows the ability of an end-user devices 15 through multiple antennas 16 or a single multi-network capable antenna 16 to acquire both the Control Channel as well as the wireless channel for the Carrier Network 23. The separate control channel network and/or the wide-area wireless transport networks may include various high-speed high-bandwidth wireless transport platforms using technologies such as CDMA 2000, CDMA-EVDO, CDMA-EVDO Rev A, WCDMA, HSDPA, WiMax, WiFi, LTE and other and additional next generation high-speed and high-bandwidth wireless data networks 18. FIG. 2 shows a server for control and signaling control of the Control Channel independent of the wireless transport carriers 18 and a data-base for end-user information and customer usage and data repository 20 independent of the Carrier Network. The wireless control channel network is shown as a paging network, a satellite network, or other independent wireless network 17 (i.e., the command/control system 17), or other network that provides the ability to deliver commands over the Control Channel or otherwise to the command receipt chip 11 independent of the wide-area wireless transport carriers 18 (i.e., the exemplary Carrier Network 18). Also shown are alternative mechanisms for receiving network change, and/or command and control implementation validation, either through a two-way wireless command and control channel 22 or through a signaling channel link over IS-41, SS7 MAP links, ENUM telephone number mapping or directly through an Internet Protocol link 21.

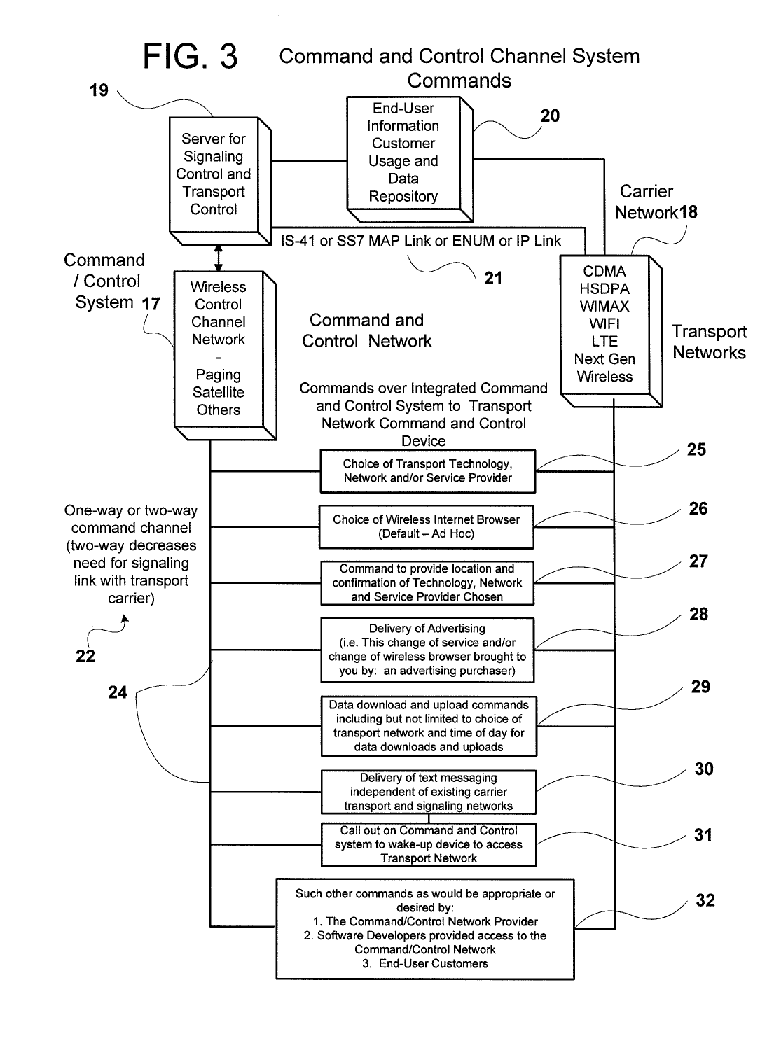

FIG. 3 is a listing of command and control channel system commands, information and/or services that can be delivered over an independent wireless control channel and/or Control Channel to an Integrated Control Network and Transport Network Command and Control Device 14 that is integrated with both a command and control wireless network and various alternative wireless transport networks and/or Carrier Networks 18. FIG. 3 shows various commands that can be delivered over an independent command and control wireless channel 24. These commands include a choice of transport technology, network and/or service provider 25, a choice of default or ad-hoc wireless internet browser 26, a command to provide location of the end-user device and confirmation of service platform acquisition to provide for, among other things, delivery of new independently controlled Location Based Services (LBS) 27, a command for the delivery of advertising directly to the end-user device through the command and control channel independent of the wide-area wireless network transport provider 28, a command for data download and/or upload, including but not limited to, choice of network or Carrier Network and/or time of day 29. The delivery of text messaging independent of the Carrier Network 30. The ability to send signals on the command control system and/or Control Channel to wake-up a device and cause it to then access, upon such a wake-up, the selected Carrier Network 31. Such other commands as would be within the scope and capability of the command and control network and/or Control Channel, along with the ability to open this control platform and/or Control Channel to third party software providers and to end-users 32. Such additional services may include, but not be limited to, alerts delivered over the Control Channel and/or the Carrier Network.

Embodiments provide a terminal device (the “Terminal Device”) that can acquire multiple broadband carrier telecommunication networks (the “Carrier Network”) and can also be instructed by a Linked Control Device, via a control and instruction channel or link, using a separate chip and wireless service radio on the Linked Control Device able to acquire and receive communications from a network independent from the networks of existing broadband wireless carriers (the “Control Channel”) and which Linked Control Device also provides for implementation of commands from the Control Channel when physically linked or connected to the Terminal Device. Embodiments of the Linked Control Device allow for commands and instructions to be issued over the Control Channel to the Linked Control Device to then provide instructions and commands to a Terminal Device, a group of devices, and/or end-user terminals, to determine which technology will be deployed for the transport of voice and/or data, and which Carrier Network acquired by a defined group of end-user Terminal Devices, and in what order. Accordingly, this application relates to a Linked Control Device for a segregated, and independent, wireless command and control over the Control Channel of wireless service selection, wireless transport and wireless communications routing. Embodiments provide for control of the initiation, monitoring, and control of the routing and/or path for the transmission, transport, and delivery of data and/or voice services over a selected Carrier Network. Embodiments provide for, among other things, Carrier Network independent control and delivery of selected services, wireless voice and/or data service and/or SMS technology and transport selection and/or least cost routing over wireless networks and a selected Carrier Network through commands sent to the Linked Control Device.

Examples of a Linked Control Device embodiment would use, for example, but not limited to, linking to a multiple technology service chip-set, or the serial linking of separate network components or chip-sets on a common platform, along with the use of an external network for the Control Channel, such as, for example, a paging network and paging transceiver to receive the paging or independent Control Channel wireless command, or a satellite link antenna and chip, or other system (as illustrated in the FIGURES), to receive the independent Control Channel wireless command. Embodiments then direct the multiple network chip or the multiple network configured end-user terminal through the Linked Control Device embodiment to, in turn, acquire a third party network or wireless platform or Carrier Network in the priority and/or order directed, and with the services and capabilities then directed. This Control Channel can also be used for the independent and direct delivery through the Linked Control Device of services directly to end-user devices separate from a Carrier Network and/or integrated with a Carrier Network as determined by the controlling party or entity of the Control Channel.

An additional highly desirable capability of such a Linked Control Device embodiment is the receipt of confirmation that the commands, instructions and/or controls delivered over the Control Channel have been received and acted upon.

Simply put, the deployment of the Linked Control Device embodiment to control choice of wireless networks for groups of users over a separate Control Channel will, among other things, bring to enterprise and group purchasers of wireless services the same benefits and controls that resulted from the development and rapid market acceptance of long-distance network choice and least-cost purchase of services over long-distance networks.

In operation, an enterprise, and/or an intermediary representing one or more enterprises or group of end-users, will acquire for a group of users a Terminal Device containing a multi-network acquisition capability along with the capability of connecting to and receiving commands from the Linked Control Device embodiment. Embodiments will provide for the ability to choose for the Terminal Device a Carrier Network for the delivery of voice and/or data services and/or SMS. The Linked Control Device will also have the ability to receive through the Control Channel a command and/or instruction that will then determine for the Linked Control Device the Carrier Network to be used by the Terminal Device. This Linked Control Device along with the Terminal Device will also have the ability to communicate to the enterprise and/or intermediary that the commands, controls and/or instructions delivered over the Command Channel have been successfully received, acted upon and/or implemented. This may include commands, controls and/or instructions for additional independent services delivered over the Command Channel and/or integrated with the Carrier Network. Upon deployment and linking of the Linked Control Device into or integrated with the Terminal Device and the system and platform supporting the Control Channel, the enterprise and/or intermediary will choose the technology and/or Carrier Network for users or groups of users based upon service and technology availability, geographic area, capacity, capacity by time of day and/or cost and/or other characteristics or elements of the Carrier Network. The Linked Control Device linked to the Terminal Device will then instruct the Terminal Device to implement the command received to the Linked Control Device over the Control Channel. Embodiments then monitor reports of the receipt, action upon and/or subsequent implementation of the controls, commands and instructions delivered over the Control Channel. In some embodiments, the process will be repeated at periodic intervals to optimize the use of wireless transport and its cost by the enterprise or by the intermediary.

The following describes in further detail various of the elements and capabilities of embodiments for the segregated, and/or the independent command and control of wireless service selection, routing, transport and/or delivery.

As a result of the deployment of an embodiment, an independent telecommunications Control Channel, or link, one or more, or a combination of, all or part of the following is provided:

a. A direct wireless channel, wire line channel, or link to a Linked Control Device that connects to or is subsequently connected to a Terminal Device,

b. A wireless channel, wire line channel, or link to a Linked Control Device independent from existing Carrier Network and wide-area network voice and data systems,

c. A wireless channel, wire line channel, Control Channel and/or link able to access a Linked Control Device that is linked directly or later to a Terminal Device that has the capability of accessing multiple wireless networks,

d. The ability over the wireless channel, wire line channel, Control Channel and/or link to deliver instructions to the Linked Control Device linked directly or later to the Terminal Device to choose and cause the implementation of the choice of separate wireless networks for the transport of voice and/or data services,

e. The ability to receive confirmation that the instruction to select and deliver voice and/or data services over the selected wireless transport network or Carrier Network has been received and implemented.

Another set of capabilities and characteristics of the Linked Control Device embodiments is the ability to directly receive and act upon independent commands and telecommunications over a wireless channel, wire line channel, link and/or Control Channel. An embodiment may be comprised of one or more, or all of, the following:

a. A receiving antenna and chip set that allows for receipt of independent commands and/or instructions,

b. A microprocessor with the capability of translating received commands and/or instructions including but not limited to commands, controls or instructions delivered over the Control Channel for additional action,

c. Software instructions for receiving and acting upon independent commands and/or instructions received,

d. A send and receive antenna and chip set in the Terminal Device able to select and communicate with the Control Channel and separately communicate with the Carrier Network, apart from the Control Channel,

e. A USB port, SD Card, microcontroller and/or other interface between the Linked Control Device and the Terminal Device,

f. The software program between the Linked Control Device embodiment and the Terminal Device,

g. The USB port, SD Card, microcontroller and/or other interface and integrated software program between the Linked Control Device embodiment and the Terminal Device,

h. The ability to instruct and have the instructions acted upon for the delivery of voice and/or data for transport over the selected Carrier Network.

The Linked Control Device embodiment for providing independent command, control and instructions to the Terminal Device including, but not limited to, command, control and/or instructions received over the Control Channel is comprised of one or more, or all of, the following:

a. The deployment and integrated system implementation of a server separate from the wireless carrier transport networks for command and control of the Linked Control Device embodiment independent of the Carrier Networks,

b. A data-base customer information, usage and/or data repository independent from the Carrier Networks, yet integrated for wireless transport service provisioning over the Carrier Networks,

c. The method and system for collecting data over or separate from the Control Channel and sending instructions based upon that data in connection with an individual, or groups of individual end-users, over the Control Channel,

d. The method and system for reporting of command and service implementation changes over the Control Channel, or, through the signaling channels across and from the Carrier Network.

The Linked Control Device embodiment provides for separate delivery of commands to a Terminal Device received from a Control Channel and delivered from the Linked Control Device to the Terminal Device through a USB port, SD Card, Microcontroller and/or other interface. Embodiments provide for one or more or all of the following capabilities:

a. Choice of wireless voice and/or data transport technologies, network and service provider transport and/or Carrier Network,

b. Choice of least cost routing over wireless transport networks and/or a Carrier Network,

c. Choice of the wireless internet browser to be used as the browser (default or ad-hoc) for third party wireless networks and wireless transport services including but not limited to over a Carrier Network,

d. Commands, controls or instructions over the Control Channel for the delivery of end-user equipment location information directly or over a Carrier Network or otherwise,

e. The confirmation of Carrier Network service implementation and/or completion, and the operational functioning of Carrier Network service delivery,

f. Delivery of advertising directly to end-user devices over the Control Channel,

g. Data download and/or upload commands, controls, or instructions over the Control Channel or otherwise including, but not limited to, choice of Carrier Network and/or time of day for the data downloads and/or uploads,

h. Access by software developers and/or end-user customers through application programming interfaces (APIs) to the server and system integrated with and/or controlling the Control Channel,

i. Signals and/or commands over the Control Channel to wake-up or turn-on the terminal and/or end-user communications device and to then commence a pre-determined action that may include initiating access to a Carrier Network,

j. Such other access and capability as may be determined by the controller of the independent Control Channel and such embodiments as may be technically capable of being provided over that Control Channels and related system, method and device now and in the future.

k. Such additional services may include, but not be limited to, alerts delivered over the Control Channel and/or the Carrier Network.

In summary, what is disclosed herein is an additional device and system and/or Control Channel for the independent control and delivery of commands and/or instructions, and/or wireless services determination, to wireless end-user devices, terminals and/or equipment. Embodiments provide for choosing the technology, network and/or service provider and/or Carrier Network for the transport of wireless voice and/or data services and/or SMS. Embodiments utilize an independent link or pathway to control the choice of the technology and/or transport network over the Control Channel or otherwise, and provide for an independent verification and/or confirmation of the completion of the network and/or path chosen.

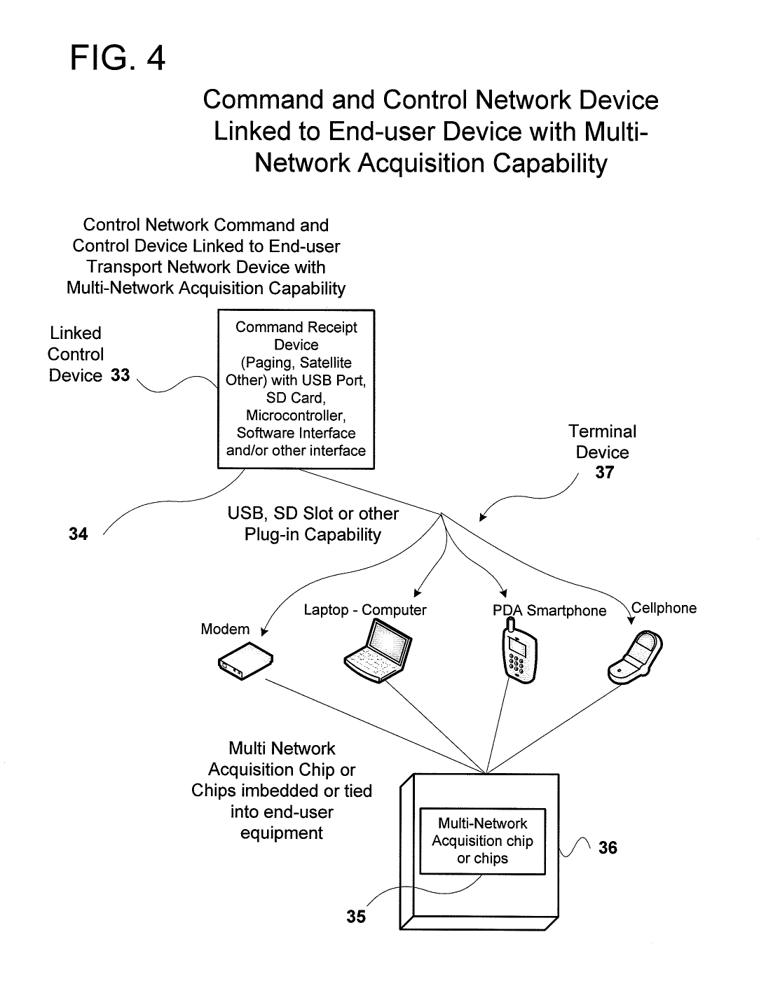

FIG. 4 is an overview of an embodiment of a Linked Control Device with Segregated Wireless Command Control and Wireless Transport. FIG. 4 provides detail with respect to a linked control device embodiment that can receive a command on a receiving Linked Control Device 33 over a separate Control Channel not controlled by a Carrier Network. Once the command is received, the command is translated through a USB Port, SD Card, microcontroller, software, wireless interface (such as, but not limited to, Bluetooth) and/or other interface 34 to command the Terminal Device 37 to acquire the Carrier Network for wireless voice and data transport. The Linked Control Device 33 and Terminal Device 37 may be deployed as separate units thus allowing for a flexible deployment of the command and control capability allowing these devices when linked to re-direct the Terminal Device 37 by a command independent of deployed wireless networks or over the Control Channel to provide for voice and data delivery over an independently selected wireless technology and/or service transport network and/or Carrier Network.

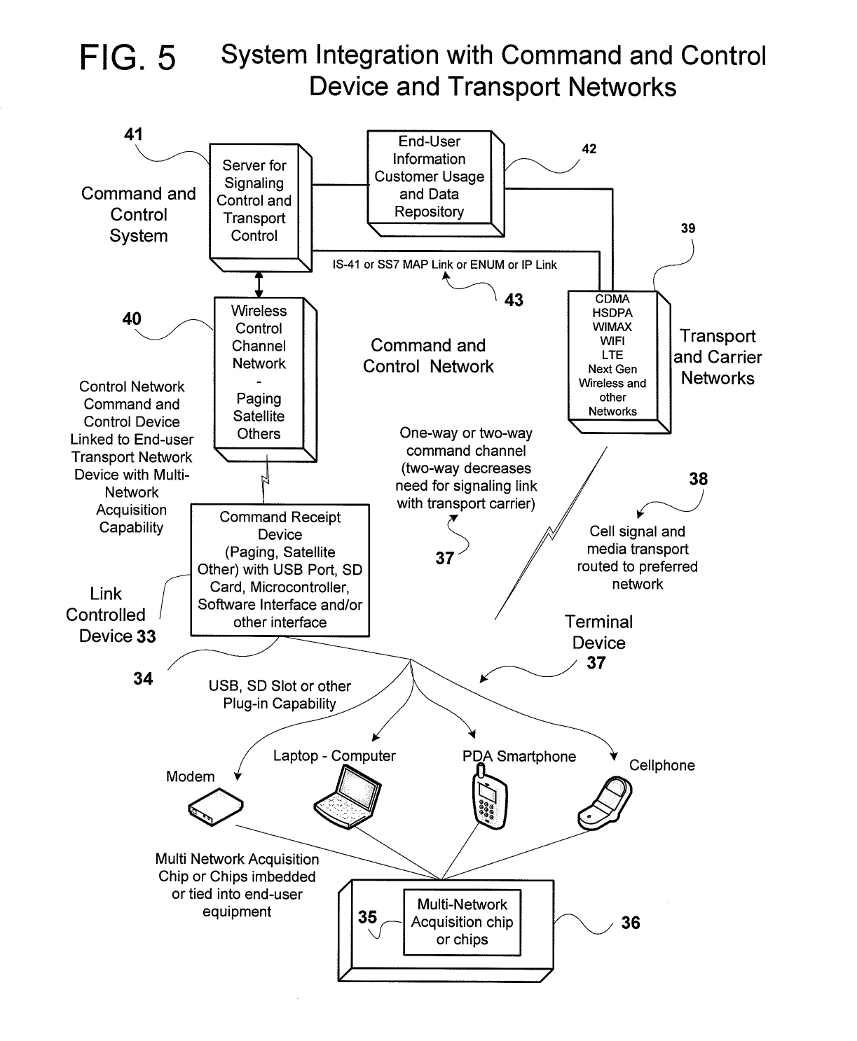

FIG. 5 is an overview of a Linked Control Device 33 linked with a Terminal Device 37 and with the wireless Control Channel 40. FIG. 5 shows how the Terminal Device is then communicatively integrated into the Carrier Network 39 and a command/control system 41 independent of the Carrier Network 39. It also shows the ability of a the Linked Control Device and the Terminal Device to link while each device acquires respectively for the Linked Control Device 33 the Control Channel 40 and for the Terminal Device 36 the Transport Network 39. The separate control channel network and/or the wide-area wireless transport networks may include various high-speed high-bandwidth wireless transport platforms using technologies such as CDMA 2000, CDMA-EVDO, CDMA-EVDO Rev A, WCDMA, HSDPA, WiMax, WiFi, LTE and other and additional next generation high-speed and high-bandwidth wireless data networks such as FLO networks 39. FIG. 5 shows a server for control and signaling control of the Control Channel independent of the exemplary wireless transport carriers 39 and a data-base for end-user information and customer usage and data repository 42 independent of the Carrier Network. The wireless control channel network is shown as a paging network, a satellite network, or other independent wireless network 40, that provides the ability to deliver commands over the Control Channel or otherwise to the Linked Control Device 33 independent of the wide-area wireless transport carriers or other wireless networks 39. Also shown are alternative mechanisms for receiving network change, and/or command and control implementation and/or validation, either through a two-way wireless command and control channel 37 or through a signaling channel link over IS-41, SS7 MAP links, ENUM telephone number mapping or directly through an Internet Protocol link 43.

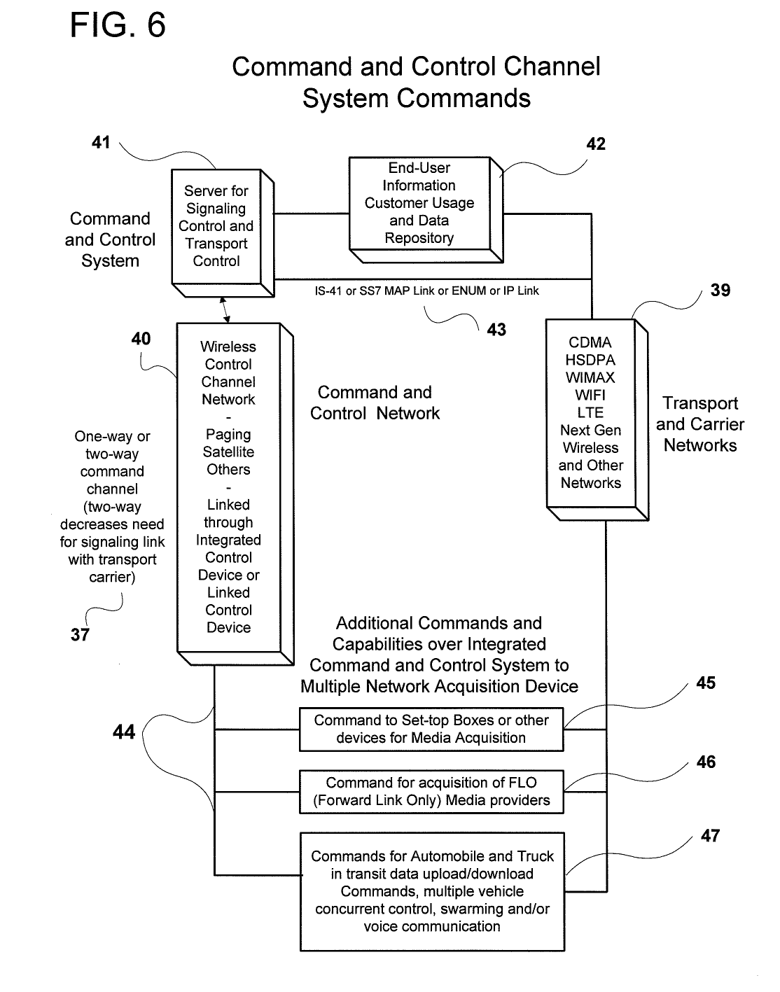

FIG. 6 is a listing of additional command and control channel system commands, information and/or services that can be delivered over an independent wireless control channel and/or Control Channel to an Integrated Control Network and Transport Network Command and Control Device embodiment or to a Linked Control Device 33 and Terminal Device 44 that is integrated with both a command and control wireless network and various alternative wireless transport networks and/or Carrier Networks 39. FIG. 6 shows additional commands that can be delivered over an independent command and control wireless channel 40. These additional commands include a command to a set-top or other device for voice, data and/or media acquisition and/or transport 45, a command for acquisition and receipt of media from FLO (Forward Link Only) media providers 46, commands for automobile and/or truck in transit data downloads and uploads across chosen networks and/or for multiple network concurrent control, swarming control and/or other voice and data communication 47.

Low Power Wireless Signal Repeater Embodiment

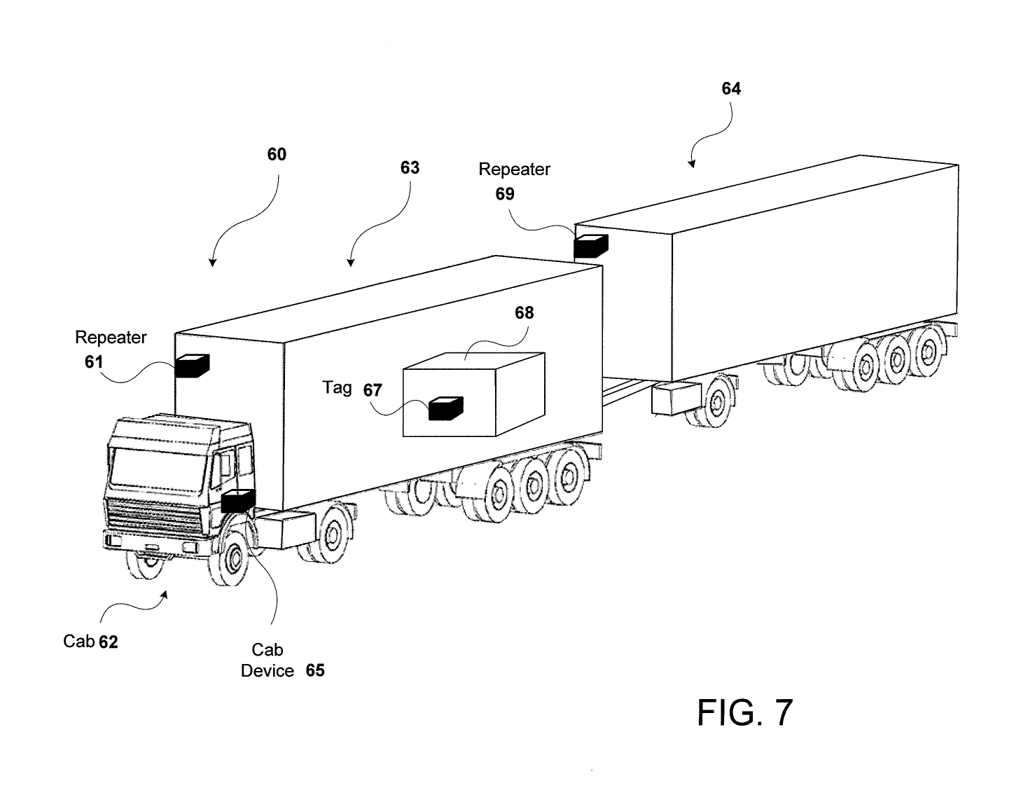

FIG. 7 illustrates a truck 60 that includes a low power wireless signal repeater 61. The exemplary truck 60 includes a cab 62 and a first trailer (or semi-trailer) 63. The trailer 63 includes electrical wires that connect to the cab 62 for powering lights and in many cases an antilock braking system (ABS). In this embodiment, the cab includes an exemplary low power wireless data communication device 65 (e.g., a radio frequency identification device (RFID) transponder) embodiment. The trailer 63 includes a repeater device 66 embodiment that receives a transponder signal from the cab device 65, relays the received transponder signal as a second transponder signal toward an unpowered tag 67 embodiment located on a payload 68 in the trailer 63. The repeater device 61 embodiment, in an exemplary embodiment, receives its power from the received transponder signal. The exemplary tag 67 uses the received second transponder signal to transmit an identification signal and other payload information to the repeater 61. The repeater 61 relays the identification signal and other payload information to the cab device 65. The cab device 65 delivers information of interest, such as, but not limited to, the trailer identification signal and payload identification signal and other payload information across the Control Channel (e.g., control network) or the Carrier Network. In an additional embodiment, the trailer identification signal and payload identification signal is buffered or stored for later forwarding from either the trailer transponder 61 (repeater 61) and/or the cab device 65.

In one embodiment, the repeater 61 in the trailer 63 is powered by the Radio Frequency emissions from the cab device 65 in the cab 62. In another embodiment the repeater 61 in the trailer 63 is powered by a battery in or coupled to the repeater 61. In another embodiment the repeater 61 in the trailer 63 is powered by a solar powered device. In another embodiment the repeater 61 in the trailer 63 is powered by an alternate power supply (not shown) located in the trailer 63, which could include a wheel revolution based generator, a wind generator, a thermal differential powered generator, a fuel cell, or other onboard power generation technology. In embodiments powered by the cab RF energy, battery power, solar power, or alternate power supply, the power storage device, or battery, in the repeater can receive and store new energy from either the cab RF emissions, other RF emissions such as WiFi RF emissions and/or solar power.

FIG. 7 shows an additional embodiment whereby the repeater 61 in the trailer 63 communicates information of interest with and/or energizes a second repeater 69 in a second trailer (or semi-trailer) 64. The second repeater 69 may be energized and store power and access unpowered payload tags in the same way as the first repeater 61 from a plurality of tags. This will also apply to a third or more trailers or trailing units. Other embodiments may be deployed in other vehicles or vessels, such as, but not limited to, multi-car trains, ships, aircraft, busses, passenger trains, or other transportation units.

In an exemplary embodiment, the repeater 61, the cab device 65, the second repeater 69, the tag 67, and other components, systems and devices are configured to communicate under the Society of Automotive Engineers (SAE) J1939 standard. The SAE J1939 standard is the vehicle bus standard used for communication among the various vehicle components. SAE J1939 formatted communications may be used in the commercial vehicle area for communication throughout the vehicle. Other embodiments may employ any suitable communication standard and/or format.

System for Allowing Application Connection Thru Multiple Carrier Platforms

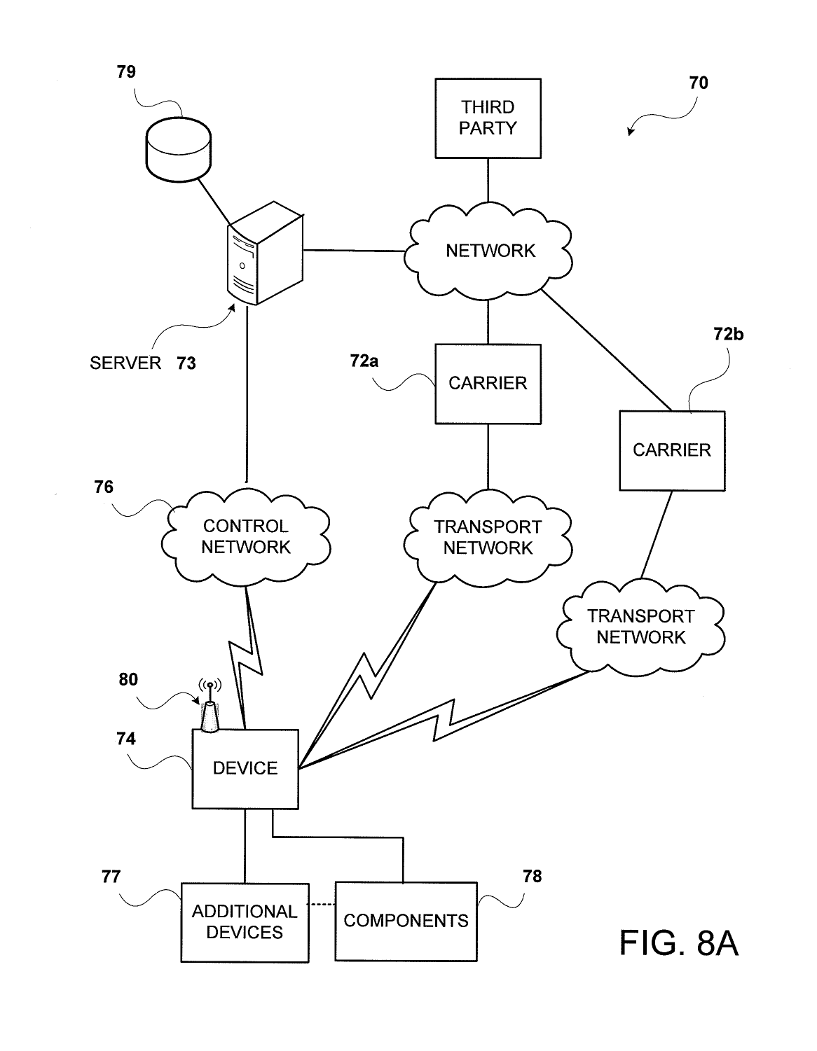

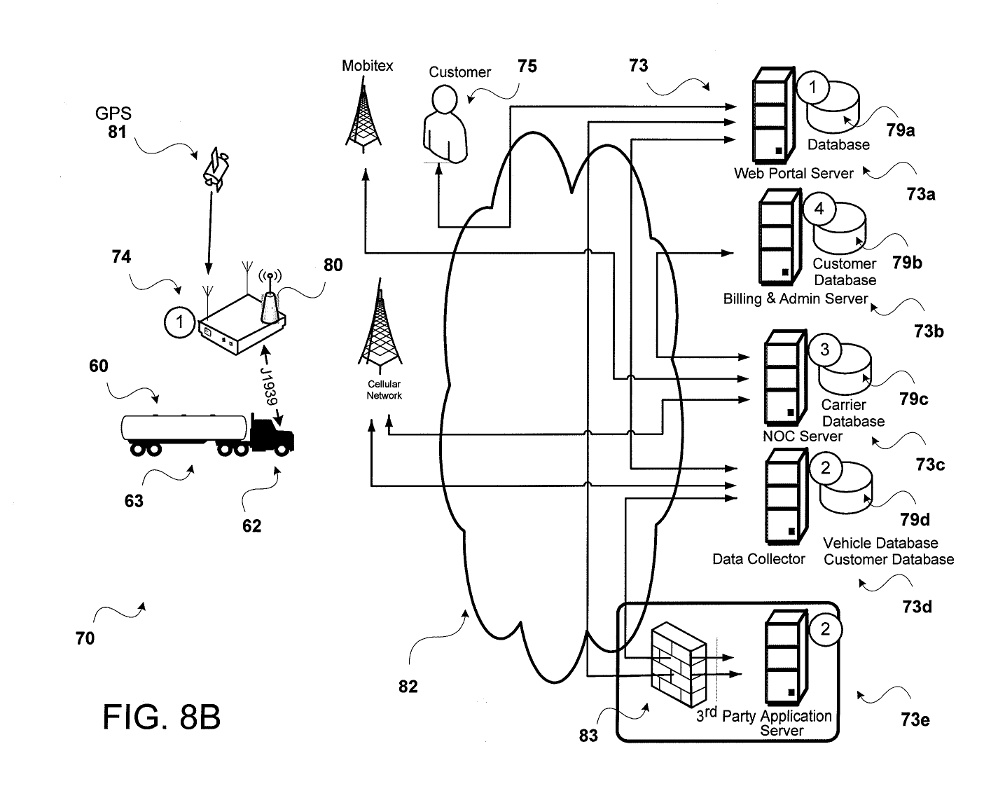

FIGS. 8A and 8B illustrate various environments and architectures used in exemplary embodiments. For example, FIG. 8A illustrates a system 70 that allows an application produced by a third party 71 to have access to data provided to one or more wireless carriers 72a, 72b from their providers. The third party application may be hosted on a server 73 not associated with any of the wireless carriers 72a, 72b. The server 73 includes software components that convert as necessary data received from a carrier in the format necessary for the third party application. Also, the server 73 includes software components that convert as necessary data received from third party application in the format necessary for the carrier and device 74. The device 74 is comparable to the controlled device embodiments discussed in FIGS. 1-7 above. Alternately the device 74 can be any type of device which communicates wirelessly, whether or not is meets the “controlled device” description in the FIGURES above.

In another embodiment, the software component located on the server 73 may be distributed across the other systems (carriers, device, third party) shown in FIGS. 8A and 8B.

Emulator

In one embodiment, the system 70 may emulate different interfaces so that customers don't have to make significant information technology (IT) changes in order to switch from one telematics provider to a new one. The customer's IT system uses the same connection types, data formats, and communication protocols as with the previous provider (for the connection between the customer system and the “emulator”). The emulator then transforms/translates/etc. the information and connects it with the telematics system in use. This concept allows a customer to use multiple telematics providers simultaneously, and it can also be applied on the device end allowing the customer to use multiple devices simultaneously with the same telematics system.

Singular system for sales, distribution, and installation of systematic application components. In this implementation a server 73 is used to make business solutions available to customers. When a customer selects a solution the server 73 invokes the necessary resources to ensure the necessary solution components are installed in all affected components of the system. For example, as shown in FIGS. 8A and B, if a customer 75 selects a business solution which automatically tracks shipment delivery status, miles traveled, and customer signatures of receipt, the following components would be distributed, installed, and configured to operate. A third party would receive a local application or applet to run on their local machines (computers). The device 74 would receive a local application, applet, configuration file, firmware or combination of these. The affected additional devices (for example a bar code reader or scanner) would receive a local application, applet, configuration file, firmware or combination of these. All of these combined provide a single solution and would require the customer to only select the solution once and all components would automatically put in place.

FIG. 8A show that additional devices 77 with communication capabilities that are connectable to the device 74. In one embodiment, use of the additional devices 77 is dynamically controlled by the server 73 via communications through the control network 76 (e.g., the control channel), which itself may be any suitable wireless network, such as, but not limited to, a carrier network. Examples of additional devices 77 include, but are not limited to, a phone, a personal computer, a game console, etc. The connection between the additional devices 77 and the device can be wired or wireless (such as Wifi, Bluetooth, etc.)

In another embodiment, the additional devices 77 may be used as a power and data storage source for an unpowered transponder device, such as an RFID transponder. For example, the RFID transponder may be attached to a cell phone. For example, but not limited to, the user can then scan payload 68 in the trailer 63 (FIG. 7) using the RFID transponder attached to the cell phone. When the user returns to the cab 62, the RFID transponder and/or the cell phone passes any collected identification (ID) and payload information to the device 74 for delivery. In one embodiment, RFID capability is built into the cell phone (i.e., additional device) for use in scanning items.

In another embodiment, the device 74 is in communication with other components 78 (sensors, actuators, engine or other controls) within the vehicle that is hosting the device 74. The device 74 acts as a router and gives IP addresses to any additional devices 77 or to the components 78. This not only allows the components and the additional devices 77 to send information, but also allows the server 73 to record status of those devices 77 and/or components 78, and dynamically control them. This embodiment may also be implemented such that each additional device 77 and/or component 78 is given a static IP address which never changes. (The additional devices 77 and components 78 may be interchangeably referred to herein as a controlled device 77, 78.)

In another embodiment, if the device 74 requests the delivery or needs to upload or download a file of significant size, then the system 70 can simultaneously utilize two or more of the available channels, such as, but not limited to, the Control Channel and/or one or more of the Carrier Networks (e.g., wireless carriers 72a, 72b) for delivery of the file. The use of multiple channels can be initiated by the device 74 or by the server 73. Example channels are voice, data, short message service (SMS), and control. For example, if a user desires to download a movie residing in a database 79. The server 73 may separate the movie into components, and then may simultaneously, or near simultaneously, send the separate movie components to the device 74 via the multiple channels. The device 74 includes a software component that recombines the separately received movie components. The server 73 or device 74 can perform the delivery at a time that would result in the most cost effective delivery over one or more of the data channels.

In another embodiment, the device 74 shown in FIGS. 8A and 8B may include a single antenna 80 that is coupled to the internally located radio components. The device 74 includes a software component that configures signals for transmission over the antenna 80 based on the air interface technology being used, the antenna type and/or the cellular network communication protocol being used.

In another embodiment, a software configured antenna 80 is used whereby the antenna 80 is dynamically tuned in such a way that no matter where it is mounted, the antenna 80 will uniquely optimize its radio frequency emission pattern to best match its current operating environment about the vehicle device 74 and/or the vehicle (such as the exemplary truck 60).

In another embodiment, the software configured antenna 80 described above may be dynamically adjusted based current location, as received from a global positioning system (GPS) system 81 or other similar location aware technology. Information, such as, but not limited to, current direction of travel, current speed, and calibration data related to said conditions may be determined. The aforementioned calibration data may be preprogrammed in the device 74 or received in real time, or near real time, over one of the wireless communication channels or control channels. This embodiment may be used to assist wireless reception in vehicles, such as the exemplary truck 60, which are travelling through territory where wireless coverage is marginal. For example the truck 60 may be driving in an area where it cannot receive cellular coverage with a traditional antenna. However, with suitable calibration data, the device 74 could tune its antenna 80 to receive a weak signal, for example from a tower far off to its side, or ahead.

The device 74 or server 73 is able to record effects of the environment and associate those recorded effects with location information. This information can be saved and delivered to other devices or vehicles that travel through or near the same location. When the other device receives the delivered environmental effects, a software component will calibrate transmit or receive radio components in order to compensate for the received environmental effects.

The device 74 may be comparable to the controlled device embodiments discussed in FIGS. 1-7 above. For example, but not limited to, the device 74 may correspond to the cab device 65, and the additional devices 77 may correspond to the repeater 61, 69 and/or the tag 67.

Multiple IDs

In another embodiment, the device 74 has one or more pre-assigned multiple identifiers (ID) which are stored locally. Each separate ID may be assigned to a different network or channel. For example, one ID may be assigned to the Control Channel and another assigned to a Carrier Network (e.g., wireless carriers 72a, 72b). A third ID may be assigned to an additional Carrier Network. This device and ID assignment configuration allows for voice, data and/or SMS messages to be delivered over alternate networks or channels by choice of an ID in the device. This exemplary configuration allows for delivery of voice, data and/or SMS messages over different networks 82 simultaneously and according to pre-determined transport or business rules such, as for example, voice delivery and receipt using a designated ID and Carrier Network by time of day, by device location and/or by other pre-determined transport and business rules. Another example would be the delivery of data using a different Carrier Network or the Control Channel according to pre-determined transport or business rules such, as for example, using a designated ID and Carrier Network by time of day, by device location and/or by other pre-determined rules. Another example would be the delivery of SMS messages using a different Carrier Network or the Control Channel according to pre-determined transport or business rules such, as for example, using a designated ID and Carrier Network by time of day, by device location and/or by other pre-determined rules. Significantly, the underlying ability of the device 74 and/or system 70 to change out the choice of Carrier Network also allows each of these ID and network choice configurations to be changed on an ad-hoc basis or at selected intervals of time. Each of the ID's may also have an applicable Priority Roaming List (PRL) that can be altered by the server 73 according to transport rules, business rules and/or other pre-determined or later determined transport and/or data rules.

FIG. 8B illustrates exemplary servers 73a-73e that may be in communication with the device 74. For example, the server 73a may correspond to a web portal server or the like that provides information, data, software, applications, applets, or the like, such as from its respective database 79a. The server 73b may correspond to a billing and administration server or the like that provides billing information, administrative information, or the like, such as from its respective customer database 79b. The server 73c may correspond to a network operations center (NOC) server or the like that provides network related information, such as from its respective carrier database 79c. The server 73d may correspond to a data collector server or the like that collects and/or provides information, such as from its respective vehicle and/or customer database 79c. The server 73e may correspond to a secure third party application server protected by a firewall 83 or the like.

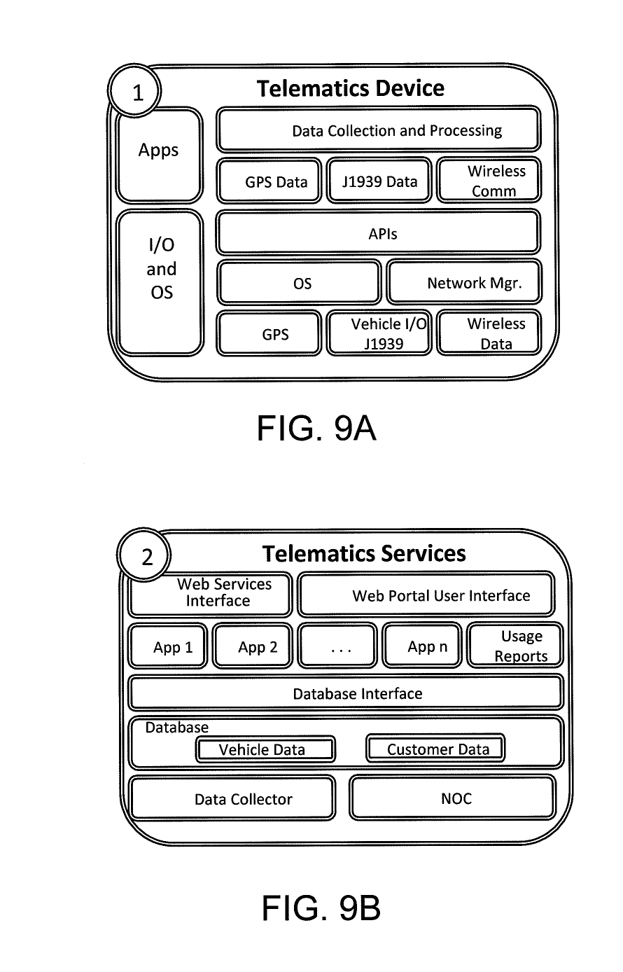

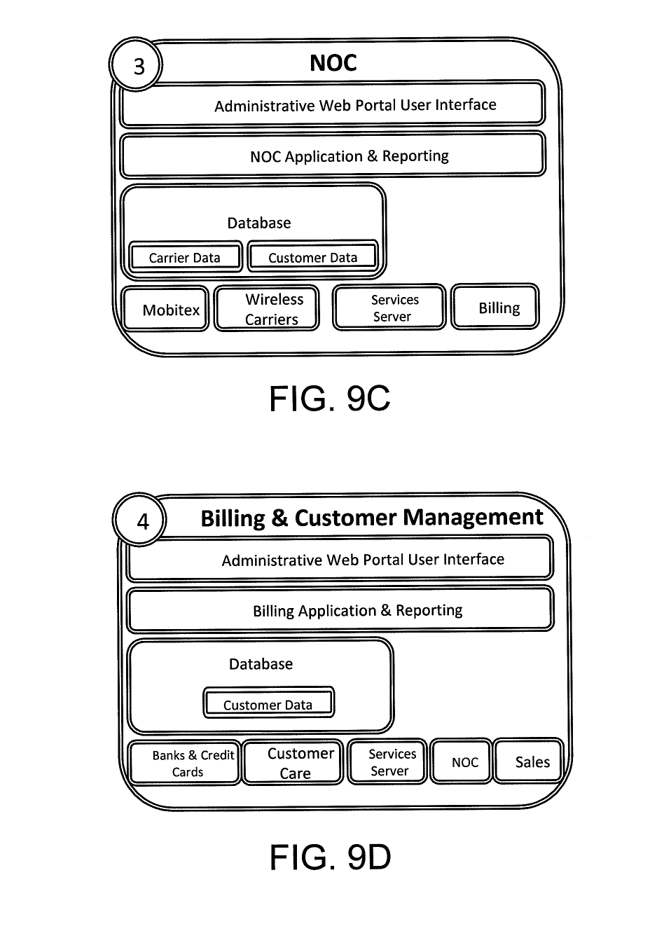

FIGS. 9A-9B illustrate example software components located on the exemplary device 74 and/or servers 73a-73e of FIG. 8B.

FIG. 9A of an exemplary device 74 implemented as a telematics device (1) configured to transmit and/or receive telecommunications and information in an integrated fashion. The exemplary telematics device (1) may include an applications (Apps) module or portion, an input/output (I/O) and operating system (OS) portion, a data collection and processing portion, an application programming interface (API) portion, an operating system portion, a network manager (Mgr.) portion, a GPS device portion, a GPS data portion, a vehicle I/O j1939 portion, a J1939 data portion, a wireless communication (Comm) portion, and a wireless data portion. Other telematics devices (1) may have fewer components, or may include additional components not described herein. The portions may be implemented or separately provided as devices, as systems, or as memory media. Some portions may be integrated with each other.

FIG. 9B of an exemplary telematics services (2) embodiment implemented as a server 73 that is configured to transmit and/or receive telecommunications and information in an integrated fashion. The exemplary telematics services (2) embodiment may include one or more applications (Apps) module or portion, a web services interface, a web portal user interface, a usage reports portion, a database interface, a database portion (with vehicle data and/or customer data, for example), a data collector portion, and a NOC portion. Other telematics services (2) embodiments may have fewer components, or may include additional components not described herein. The portions may be implemented or separately provided as devices, as systems, or as memory media. Some portions may be integrated with each other.

FIG. 9C of an exemplary server 73 implemented as a NOC (3) configured to transmit and/or receive network operating information in an integrated fashion. The exemplary NOC (3) may include an administrative web portal user interface portion, a NOC application and reporting portion, a database portion (with carrier data and/or customer data, for example), a mobitex portion, a wireless carrier portion, a services server portion, and a billing portion. Other NOCs (3) may have fewer components, or may include additional components not described herein. The portions may be implemented or separately provided as devices, as systems, or as memory media. Some portions may be integrated with each other.

FIG. 9D of an exemplary server 73 implemented as a Billing and Customer Management (4) system configured to transmit and/or receive billing and/or customer information in an integrated fashion. The exemplary Billing and Customer Management (4) system may include an administrative web portal user interface portion, a billing application and reporting portion, a database portion (with customer data, for example), a banks and credit card information portion, a customer care portion, a services server portion, a NOC portion, and a sales portion. Other Billing and Customer Management (4) systems may have fewer components, or may include additional components not described herein. The portions may be implemented or separately provided as devices, as systems, or as memory media. Some portions may be integrated with each other.

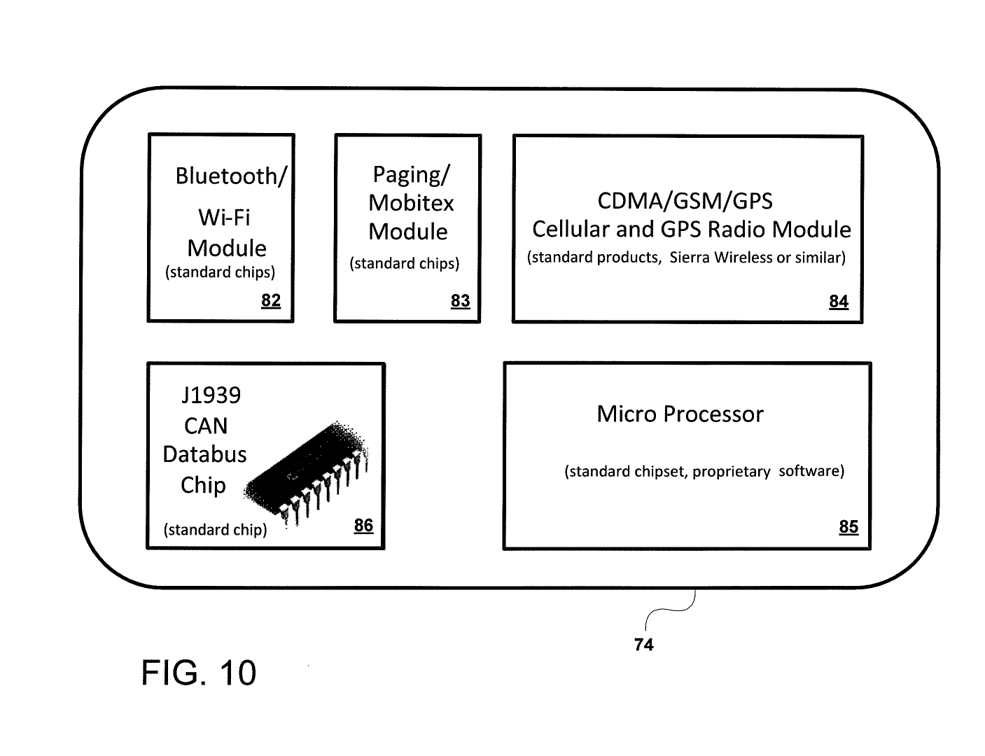

FIG. 10 illustrates an exemplary software and hardware architecture used in an exemplary embodiment of the device 74. The exemplary device 74 comprises a Bluetooth and/or Wi-Fi module 82, a paging and/or mobitex module 83, a CDMA, GSM, and/or GPS cellular and/or GPS radio module 84, a microprocessor 85, and/or a J1939 (CAN) data bus chip 86. The modules may be implemented or separately provided as devices, as systems, or as memory media. Some modules may be integrated with each other.

In one embodiment, routing of voice calls, data transmissions and SMS messages between the driver's phone and the in-vehicle device is based upon local conditions and associated business rules. Examples of the local conditions include:

time of day;

geographic location (e.g., road type, such as freeway or arterial);

vehicle condition (speed, direction, gear that the vehicle is in, acceleration, etc.); or

weather conditions at the vehicle's location.

All or any combination of the above can be used in the various embodiments.

For example, a call may be delayed or changed from voice to text and delivered to the in-vehicle device 74 instead of the driver's cell phone based upon business rules and the local conditions. This is performed in order to keep from distracting the driver during a period of heavy workload, night, and/or during bad weather.

In one embodiment, the delivery of a call, voice message and/or SMS message is buffered until the state or condition of the vehicle (such as the exemplary truck 60) changes according to predefined threshold(s) (e.g., the business rules). When the threshold condition(s) is met, then the call or message is delivered.

In an exemplary embodiment, a call to a driver's cell phone may be intercepted according to the rules/conditions, and then routed to mail service component in the vehicle device 74. This can be implemented with a voice over IP service. The device 74 can also record an audit trail of when this interception application is active.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A system for communicating with vehicles, comprising:
a vehicle device configured to communicate with a control network and at least one carrier; and
a server configured to communicate with the control network and the at least one carrier, configured to communicate command information with the vehicle device using the control network, and configured to separately communicate information of interest with the vehicle device using the at least one carrier in accordance with the communicated command information communicated over the control network.

2. The system of claim 1, wherein the vehicle device comprises:
an antenna configured to communicate the command information using the control network and the information of interest using the at least one carrier.

3. The system of claim 2, wherein the antenna is a software configured antenna configured to optimize a radio frequency emission pattern to best match a current operating environment about the vehicle device.

4. The system of claim 1, wherein the vehicle device comprises:
a global positioning system (GPS) module configured to receive location information corresponding to a current location of the vehicle device; and
a micro processor module configured to determine at least one of a current speed, distance of travel, and a current direction of travel, and configured to communicate the determined at least one of the current speed, distance of travel and the current direction of travel to the server using a selected one of the control network and the at least one carrier in accordance with a specification from the server that is communicated over the control network.

5. The system of claim 1, further comprising:
a repeater communicatively coupled to the vehicle device; and
at least one tag associated with a payload of the vehicle and configured to communicate tag information to the repeater,
wherein the repeater is configured to communicate the tag information to the vehicle device, and
wherein the vehicle device is configured to communicate the tag information to the server using a selected one of the control network and the at least one carrier in accordance with a specification from the server that is communicated to the vehicle device over the control network.

6. The system of claim 5, wherein the server is configured to communicate a request for the tag information to the vehicle device using the control network, and wherein the tag information is communicated from the tag in response to the request.

7. The system of claim 5, further comprising:
a repeater communicatively coupled to the vehicle device; and
at least one component associated with a payload of the vehicle and configured to communicate component information to the repeater,
wherein the repeater is configured to communicate the component information to the vehicle device, and
wherein the vehicle device is configured to communicate the component information to the server using a selected one of the control network and the at least one carrier in accordance with a specification from the server that is communicated to the vehicle device over the control network.

8. The system of claim 1, wherein the vehicle device is configured to control communications of a controlled device based upon command information communicated to the vehicle device using the control network.

9. The system of claim 8, wherein the controlled device is selected from a group consisting of a cell phone, a personal computer, and a game console.

10. The system of claim 8, wherein the controlled device is assigned an internet protocol (IP) address by the vehicle device, wherein the IP address is communicated to the server using the control network, and wherein the server communicates with the controlled device based on the assigned IP address.
